(19) United States
(12) Patent Application Publication
(10) Pub. No.: US 2020/0141499 A1
(43) Pub. Date: May 7, 2020

(54) VALVE DEVICE AND METHOD OF PRODUCING VALVE DEVICE

(71) Applicant: DENSO CORPORATION, Kariya-city (JP)

(72) Inventors: Yuichiro MORITANI, Kariya-city (JP); Takehiro SUGAWARA, Kariya-city (JP)

(21) Appl. No.: 16/669,733

(22) Filed: Oct. 31, 2019

(30) Foreign Application Priority Data
Nov. 6, 2018 (JP) 2018-208853

(51) Int. Cl. F16K 3/24; B23P 15/00

(52) U.S. Cl. CPC F16K 3/243; B23P 15/001

(57) ABSTRACT

A valve device has a valve element, a housing and a rotary shaft. The housing has an opening and a seal member having a cylindrical shape and arranged along the opening. The valve element is rotated by the rotary shaft in an opening direction for opening the opening and in a closing direction for closing the opening. The seal member has a first side in the closing direction and a second side in the opening direction. The seal member has a first projection protruded from an inner surface of the seal member on the first side in the closing direction and a second projection protruded from an outer surface of the seal member on the second side in the opening direction. A first end and a second end of the second projection in a circumferential direction are not connected with other parts of the seal member.

### CROSS REFERENCE TO RELATED APPLICATION

This application is based on Japanese Patent Application No. 2018-208853 filed on Nov. 6, 2018, the disclosure of which is incorporated herein by reference in its entirety.

### TECHNICAL FIELD

The present disclosure relates to a valve device.

### BACKGROUND

A passage in a valve device is sealed by rotating a valve element supported at a rotary shaft, pressing the valve element to a seal member, and then bending a lip formed at the seal member. Such valve device is applied to an engine system producing a driving force by fuel combustion.

### SUMMARY

In accordance with an aspect of the present disclosure, a valve device has a valve element, a housing that houses the valve element, and a rotary shaft that supports the valve element rotatable in the housing. The housing has an opening configured to receive fluid and a seal member having a cylindrical shape. The seal member is arranged along an inner peripheral part of the opening. The rotary shaft rotates the valve element. The valve element is rotated in an opening direction for opening the opening and in a closing direction for pressing the seal member and closing the opening. The seal member has a first side in the closing direction and a second side in the opening direction. The seal member has a first projection, a second projection, a first pressure receiving surface and a second pressure receiving surface. The first projection protrudes from an inner surface of the seal member on the first side in the closing direction. The second projection protrudes from an outer surface of the seal member on the second side in the opening direction. The second projection is located further from the rotary shaft than the first projection. The first pressure receiving surface is located between a first end of the first projection and a first end of the second projection adjacent to each other. The second pressure receiving surface is located between a second end of the first projection and a second end of the second projection adjacent to each other. The valve element has a first pressing curved surface pressing the first projection, a second pressing curved surface pressing the second projection, a first pressing surface pressing the first pressure receiving surface, and a second pressing surface pressing the second pressure receiving surface. The first end and the second end of the second projection are not connected to other parts of the seal member.

### BRIEF DESCRIPTION OF THE DRAWINGS

FIG. 1 is a schematic view of a valve device according to a first embodiment, in which an opening is opened.

FIG. 2 is a schematic view of the valve device in which the opening is closed.

FIG. 3 is a perspective view illustrating a seal member of the valve device.

FIG. 4 is a top view of the seal member.

FIG. 5 is a perspective view illustrating a valve element of the valve device.

FIG. 6 is a view of the valve device when the seal member makes a contact with the valve element.

FIG. 7 is a view of the valve device after the valve element has contacted with the seal member.

FIG. 8 is a top view of a seal member in accordance with the second embodiment.

FIG. 9 is a magnified view illustrating a first end of a second projection of the seal member in the second embodiment.

FIG. 10 is a view of the second projection after a radial end of the second projection is folded.

FIG. 11 is a top view of a seal member in accordance with a third embodiment.

FIG. 12 is a top view of a seal member in accordance with a fourth embodiment.

FIG. 13 is a schematic view taken along the line XIII-XIII in FIG. 12.

FIG. 14 is a schematic view taken along the line XIV-XIV in FIG. 12.

### DETAILED DESCRIPTION

To begin with, examples of relevant techniques will be described.

A passage in a valve device is sealed by rotating a valve element supported at a rotary shaft, pressing the valve element to a seal member, and then bending a lip formed at the seal member. Such valve device is applied to an engine system producing a driving force by fuel combustion.

The valve device whose lip is difficult to bend may lose a sealing property for the passage. Thus, techniques for making the lip bending easier and improving the sealing property are required.

In accordance with an aspect of the present disclosure, a valve device has a valve element, a housing that houses the valve element, and a rotary shaft that supports the valve element rotatable in the housing. The housing has an opening configured to receive fluid and a seal member having a cylindrical shape. The seal member is arranged along an inner peripheral part of the opening. The rotary shaft rotates the valve element. The valve element is rotated in an opening direction for opening the opening and in a closing direction for pressing the seal member and closing the opening. The seal member has a first side in the closing direction and a second side in the opening direction. The seal member has a first projection, a second projection, a first pressure receiving surface and a second pressure receiving surface. The first projection protrudes from an inner surface of the seal member on the first side in the closing direction. The second projection protrudes from an outer surface of the seal member on the second side in the opening direction. The second projection is located further from the rotary shaft than the first projection. The first pressure receiving surface is located between a first end of the first projection and a first end of the second projection adjacent to each other. The second pressure receiving surface is located between a second end of the first projection and a second end of the second projection adjacent to each other. The valve element has a first pressing curved surface pressing the first projection, a second pressing curved surface pressing the second projection, a first pressing surface pressing the first pressure receiving surface, and a second pressing surface pressing the second pressure receiving surface. The first end and the second end of the second projection are not connected to other parts of the seal member. The valve device in this embodiment reduces resistance for the second projection to bend caused by the connection of the second projection and other parts of the seal member. Easy bending of the second projection of the valve device improves the sealing property for the passage.

The present disclosure is achieved in various embodiments other than a valve device. For example, the present disclosure may be applied to a pipe with a valve device and an engine system including a valve device.

### First Embodiment

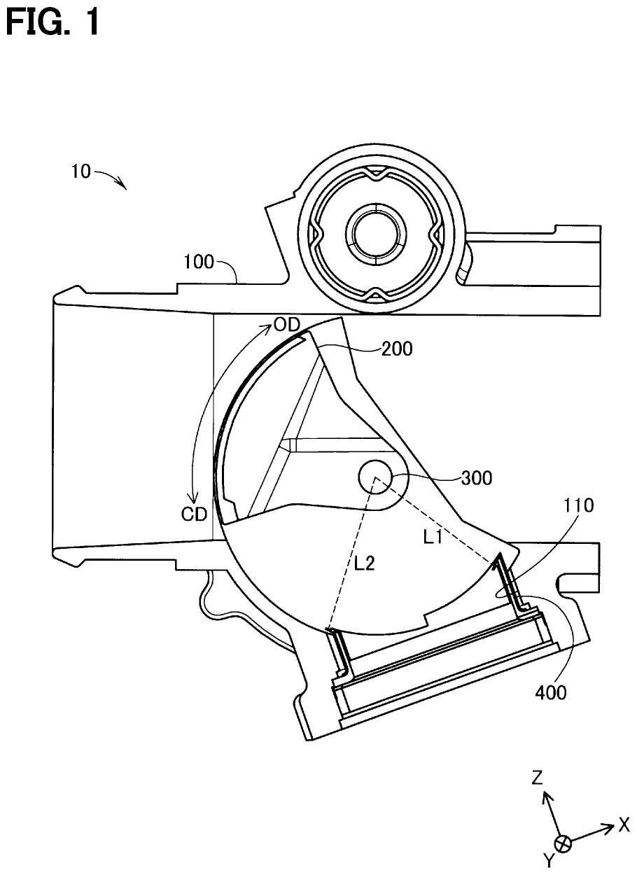

A valve device 10 in the first embodiment in FIG. 1 is a rotary valve device that regulates an opening area of a passage by rotating a valve element 200. In FIG. 1, XYZ axes in FIG. 1 are three axes orthogonal to each other in a space. The XYZ axes in FIG. 1 correspond to XYZ axes in other figures. When the intersection point of the XYZ axes is positioned at coordinate point (0, 0, 0), the direction where each arrow indicates is + direction and the opposite direction is − direction. The valve device 10 is applied to an engine system that produces driving force by fuel combustion. The valve device 10 in this embodiment is located at a connection part of an upstream intake pipe taking the outside air, a downstream intake pipe introducing the sucked air to a combustion chamber, and an EGR pipe taking the exhaust gas from the combustion chamber back to the downstream intake pipe. Z axis corresponds to an axial direction of the EGR pipe. In FIG. 1, the upstream intake pipe, the downstream intake pipe, and the EGR pipe are respectively located in the right side (X in FIG. 1), left side (−X that is opposite to X in FIG. 1), and down side (−Z that is opposite to Z in FIG. 1). The valve device 10 has a housing 100, the valve element 200, and a rotary shaft 300. In FIG. 1, Y axis corresponds to an axial direction of the valve shaft.

The housing 100 houses the valve element 200. The housing 100 has an opening 110 configured to receive fluid and a seal member 400. The opening 110 takes an exhaust gas from the EGR pipe into the housing 100. The detail of the seal member 400 is described later.

The valve element 200 is rotatable in the housing 100. As shown in FIG. 1, the valve element 200 has a sector shape, and extends in the Y axis.

The rotary shaft 300 integrates with the valve element 200 and extends in the Y axis. The rotary shaft 300 supports the valve element 200 rotatable in the housing 100.

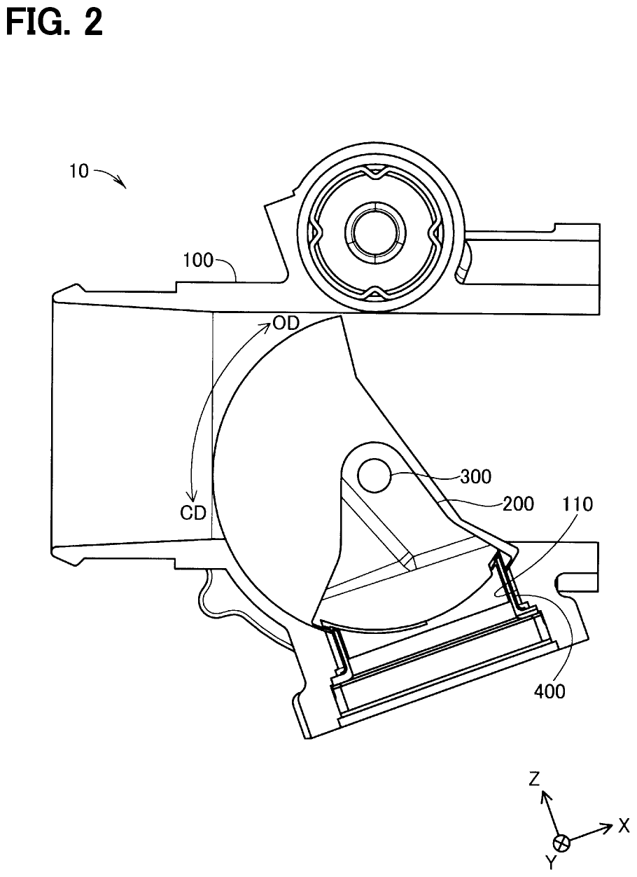

FIG. 2 shows the valve element 200 closing the opening 110. FIG. 1 shows the valve element 200 opening the opening 110. The rotary shaft 300 rotates the valve element 200. The valve element 200 rotates in the opening direction OD for opening the opening 110 and in the closing direction CD for pressing the seal member 400 and closing the opening 100. The opening direction OD is a direction where the valve element 200 rotates and is displaced from a position in FIG. 1 to a position in FIG. 2. The closing direction CD is a direction where the valve element 200 rotates and is displaced from the position in FIG. 2 to the position in FIG. 1.

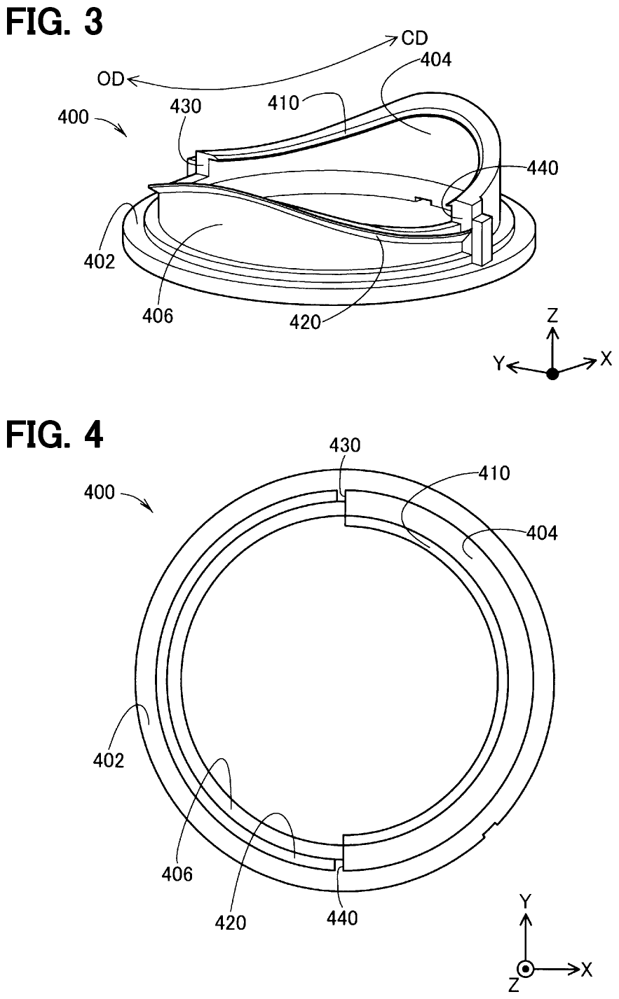

As illustrated in FIG. 3, the seal member 400 has a cylindrical shape and arranged along the inner peripheral part of the opening 110. The seal member 400 is made of a material which contains an elastic material. The seal member 400 has a first side in the closing direction and a second side in the opening direction. The seal member 400 has a protruding wall 404 protruding from the first side and a protruding wall 406 protruding from the second side. The protruding wall 404 and the protruding wall 406 protrude from an inner surface of a ring part 402 of the seal member 400 in the Z axis. The protruding wall 404 is located on the first side in the closing direction CD. The protruding wall 406 is located on the second side in the opening direction OD. The middle part of the protruding wall 404 in the circumferential direction is the highest in the Z axis of the other parts of the protruding wall 404. The middle part of the protruding wall 406 in the circumferential direction is the highest in the Z axis of the other parts of the protruding wall 406. The highest part of the protruding wall 404 is higher than the highest part of the protruding wall 406.

The seal member 400 closes the opening 110 by contacting with the valve element 200 rotating in the closing direction CD. The contact state of the seal member 400 and the valve element 200 is described later. The seal member 400 has a first projection 410, a second projection 420, a first pressure receiving surface 430, and a second pressure receiving surface 440.

The first projection 410 protrudes from the protruding wall 404 in the radial direction (−X) of the seal member 400. The first projection 410 is an approximately circular arc shape viewed in the Z axis.

The second projection 420 protrudes from the outer surface of the protruding wall 406 in the radial direction (−X) of the seal member 400. The second projection 420 is an approximately circular arc shape viewed in the Z axis.

The second projection 420 is located further from the rotary shaft 300 than the first projection 410. As illustrated in FIG. 1, a distance L2 between the center of the rotary shaft 300 and the second projection 420 is longer than a distance L1 between the center of the rotary shaft 300 and the first projection 410.

The first pressure receiving surface 430 is located between a first end of the first projection 410 in the circumferential direction and a first end of the second projection 420 in the circumferential direction adjacent to each other. The first pressure receiving surface 430 is a plane along the Z axis and the radial direction of the seal member 400. The first pressure receiving surface 430 is a circumferential end surface of the protruding wall 404 in the opening direction OD.

The second pressure receiving surface 440 is located between a second end of the first projection 410 and a second end of the second projection 420 adjacent to each other in the circumferential direction. The second pressure receiving surface 440 is a plane along the Z axis and the radial direction of the seal member 400. The second pressure receiving surface 440 is a circumferential end surface of the protruding wall 404 in the opening direction OD.

The first end of the second projection 420 is not connected to the first pressure receiving surface 430. The second end of the second projection 420 is not connected to the second pressure receiving surface 440. The first end of the second projection 420 is separated from the first pressure receiving surface 430. The second end of the second projection 420 is separated from the second pressure receiving surface 440. The first end and the second end of the second projection 420 are not connected to other parts of the seal member 400.

FIG. 4 is a top view of the seal member 400 in the Z axis. In FIG. 4, the first end of the second projection 420 is located away from the first pressure receiving surface 430 in the circumferential direction to clear that the first end of the second projection 420 is not connected to the first pressure receiving surface 430. The second projection 420 is located away from the second pressure receiving surface 440 in the circumferential direction. The distance between the first end of the second projection 420 and the first pressure receiving surface 430, and the distance between the second end of the second projection 420 and the second pressure receiving surface 440 are suitably set such that the second projection 420 provides a sufficient sealing property.

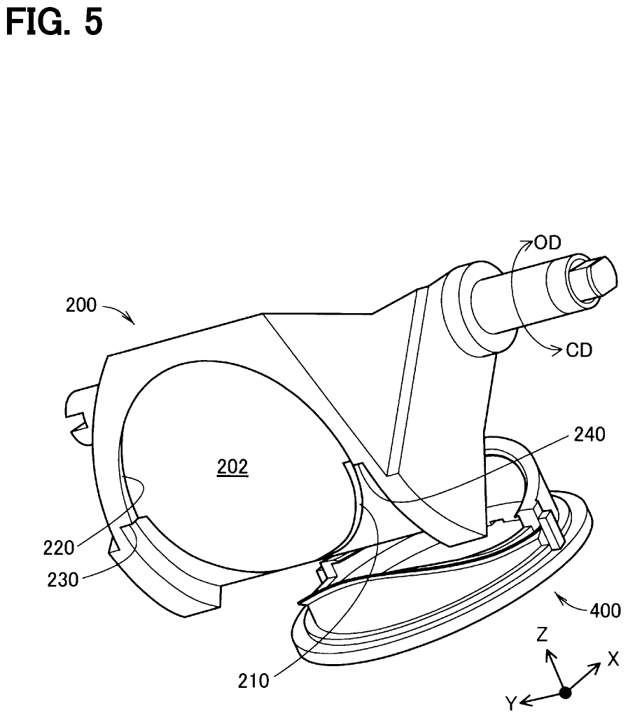

FIG. 5 explains a detail structure of the valve element 200. The valve element 200 has a cylindrical recess 202 recessed toward the rotary shaft 300 from the radially outermost surface of the valve element 200. The valve element 200 has a first pressing curved surface 210, a second pressing curved surface 220, a first pressing surface 230, and a second pressing surface 240.

The first pressing curved surface 210 is a curved surface of the valve element 200 further recessed inward in the radial direction from the cylindrical recess 202, and is extended in the circumferential direction. The first pressing curved surface 210 is located on a first side in the closing direction CD. The first pressing curved surface 210 has an approximately circular arc shape that corresponds to the first projection 410. The first pressing curved surface 210 presses the first projection 410.

The second pressing curved surface 220 is an inner side surface of the cylindrical recess 202 and has a curved shape. The second pressing curved surface 220 is located on a second side in the opening direction OD. The second pressing curved surface 220 has an approximately circular arc shape that corresponds to the second projection 420. The second pressing curved surface 220 presses the second projection 420.

The first pressing surface 230 is located between a first end of the first pressing curved surface 210 and a first end of the second pressing curved surface 220 adjacent to each other in the circumferential direction. The first pressing surface 230 faces in the closing direction CD and corresponds to the first pressure receiving surface 430.

The second pressing surface 240 is located between a second end of the first pressing curved surface 210 and a second end of the second pressing curved surface 220 adjacent to each other in the circumferential direction. The second pressing surface 240 faces in the closing direction CD and corresponds to the second pressure receiving surface 440.

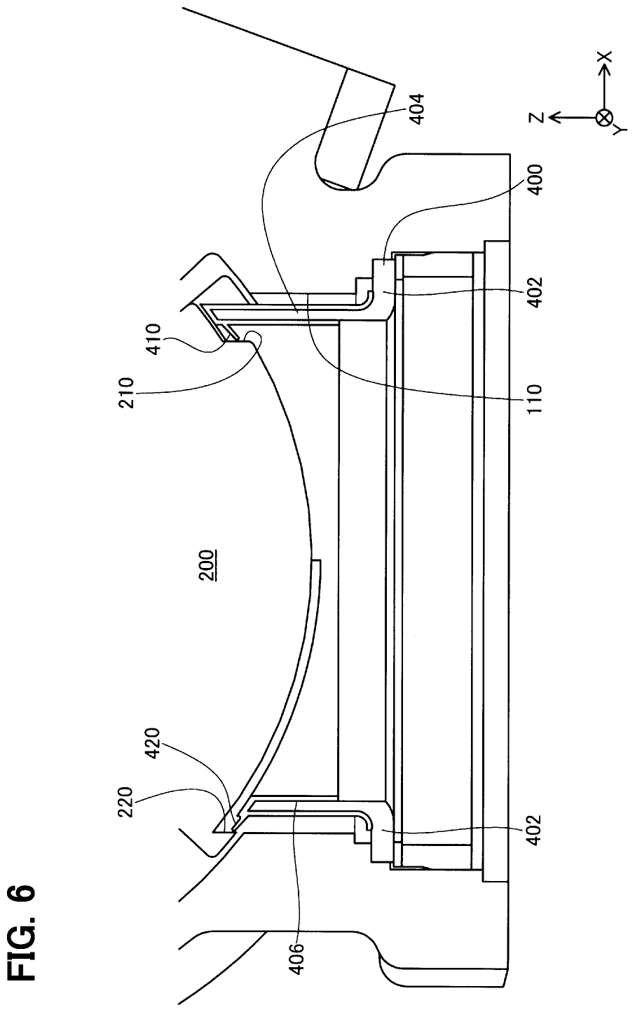

FIG. 6 explains a structure of the valve element 200 rotating in the closing direction and a moment when the valve element 200 makes a contact with the seal member 400. In FIG. 6, the first projection 410 contacts with the first pressing curved surface 210. The second projection 420 contacts with the second pressing curved surface 220.

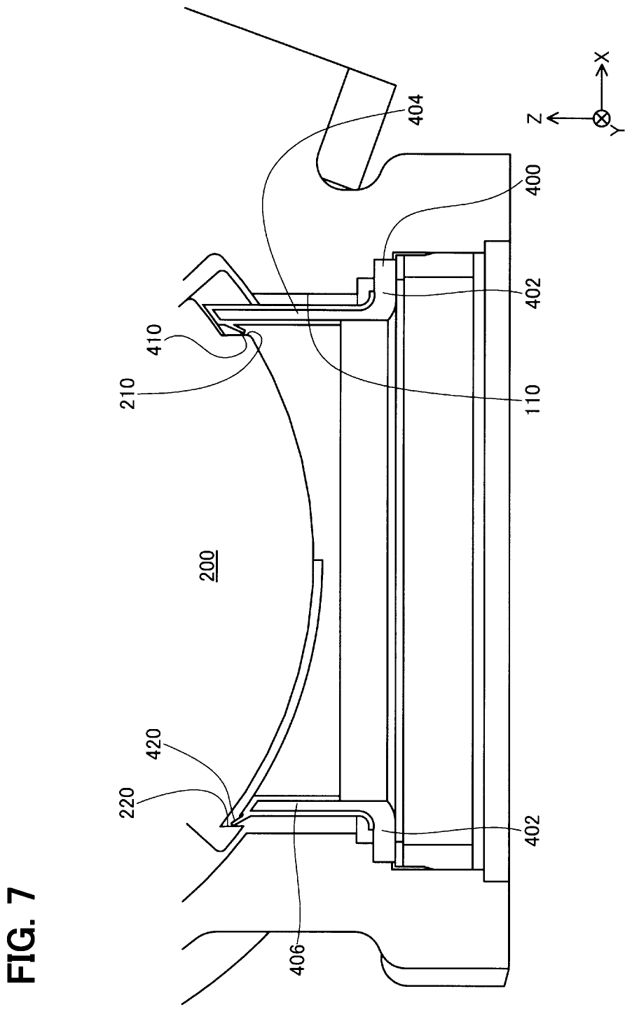

FIG. 7 explains a structure that the valve element 200 rotating in the closing direction CD has completely closed the opening 110. In FIG. 7, the first projection 410 is pressed by the first pressing curved surface 210 and bends inward the seal member 400 in the axis direction. The second projection 420 is pressed by the second pressing curved surface 220 and bends outward the seal member 400 in the axis direction. When the state in FIG. 6 changes to the state in FIG. 7, the opening 110 is closed. The EGR pipe connected to the opening 110 is closed by the valve device 10.

The valve device 10 in the first embodiment has the second projection 420 that has free ends from other parts of the seal member 400. This does not bother the second projection 420 bending. According to a comparison embodiment, the second projection 420 has a first end and a second end that are connected to the first pressure receiving surface 430 and the second pressure receiving surface 440 respectively. A connecting parts between the first end and the first pressure receiving surface 430, and between the second end and the second pressure receiving surface 440 bother the second projection 420 bending in the axis direction. The second projection in the comparison example is lower in the sealing property for the opening 110 than the second projection in the first embodiment. The valve device 10 in the first embodiment does not bother the second projection 420 bending and keeps the sealing property for the opening 110.

The first embodiment in the proceeding explanations reduces a resistance for the second projection 420 to bend. The resistance is caused by that the second projection 420 is connected to other parts of the seal member 400. The valve device in the embodiment allows the second projection 420 easy to bend and improves the sealing property for the opening 110.

### Second Embodiment

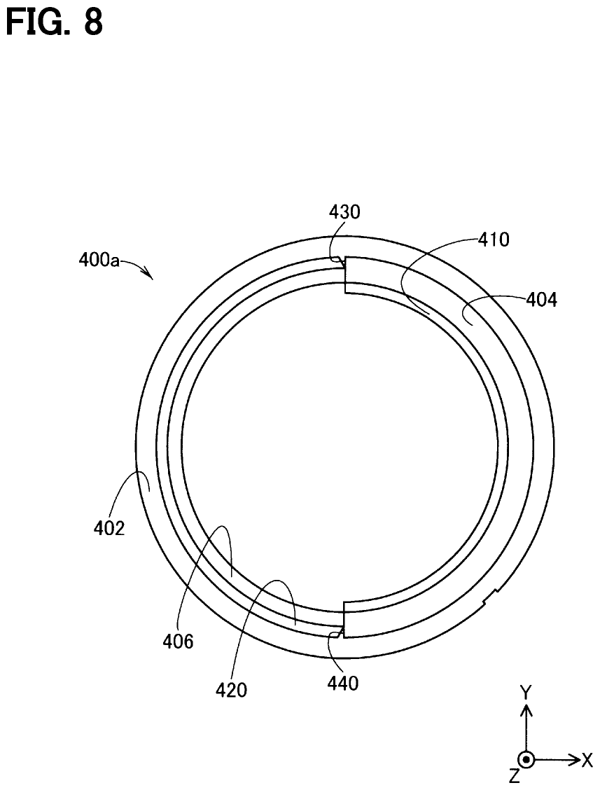

FIG. 8 shows a seal member 400a of the valve device in accordance with the second embodiment. The seal member 400a is a modification of the seal member in the first embodiment, and the shapes of the first end and the second end of the second projection 420 are different. The same symbol as the first embodiment represents the same composition in the preceding explanation.

In the seal member 400a, a gap between the first end of the second projection 420 and the first pressure receiving surface 430 gets wider from an inner side to an outer side in the radial direction of the seal member 400a. A gap between the second end of the second projection 420 and the second pressure receiving surface 440 gets wider from an inner side to an outer side in the radial direction of the seal member 400a.

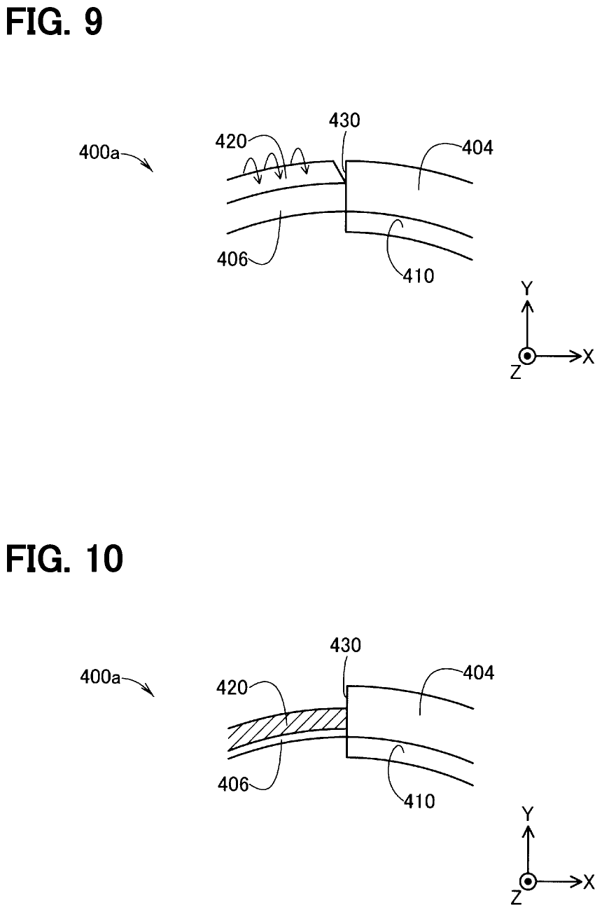

FIG. 9 is a vicinity view of the first end of the second projection 420. In FIG. 9, the illustration of the ring part 402 is omitted for easy understanding. Three arrows in FIG. 9 show the direction where the second projection 420 bends and is folded by contacting with the second pressing curved surface 220 of the valve element 200 rotating in the closing direction CD.

FIG. 10 shows a state of the first end of the second projection 420 after bending in the Z axis. In FIG. 10, the illustration of the valve element 200 contacting with the second projection 420 is omitted for easy understanding. The hatching part shows a surface of the second projection 420 after bending and the surface faced the opposite side in the axis direction before bending in FIG. 8. The second projection 420 after bending fills a space between the second projection 420 and the first pressure receiving surface 430. The same change occurs at the second end of the second projection 420.

The second projection 420 in accordance with the second embodiment described above makes it easy to fill the gaps between the first end of the second projection 420 and the first pressure receiving surface 430, and between the second end of the second projection 420 and the second pressure receiving surface 440.

### Third Embodiment

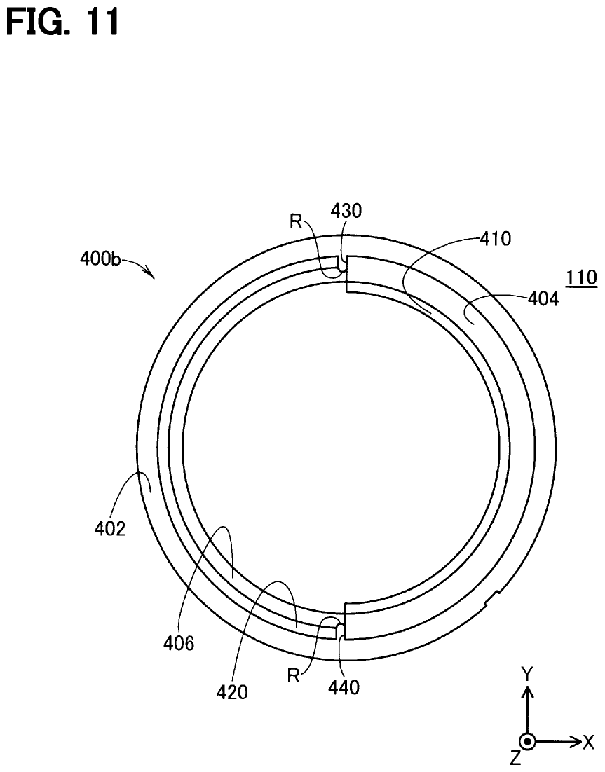

FIG. 11 shows a seal member 400b of the valve device in accordance with the third embodiment. The seal member 400b in the third embodiment is a modification of the seal member 400 in the first embodiment, and the shape of the protruding wall 406 vicinity of two ends of the second projection 420 is different. The same symbol in the first embodiment represents the same composition in the preceding explanations.

A part of the seal member 400b that connects the first end of the second projection 420 and the first pressure receiving surface 430 has a curved recess R recessed inward in the radial direction, when viewed in a depth direction of the opening 110. The depth direction of the opening 110 corresponds to the Z axis where the opening 110 extends (see FIG. 1). A part of the seal member 400b connecting the first end of the second projection 420 and the second pressure receiving surface 440 is also a curved recess R viewed in the depth direction of the opening 110. The curved recess R is recessed from the radially outer end of the second projection 420 and extends in the radial direction to define a further recess in the protruding wall 406 in FIG. 11.

Repeated bending of the second projection 420 by contacting with the second pressing curved surface 220 causes splits of the parts of the seal member 400b, since the first end and the second end of the second projection 420 are respectively connected with the first pressure receiving surface 430 and the second pressure receiving surface 440. The valve device in the third embodiment described above can suppress the splits.

### Fourth Embodiment

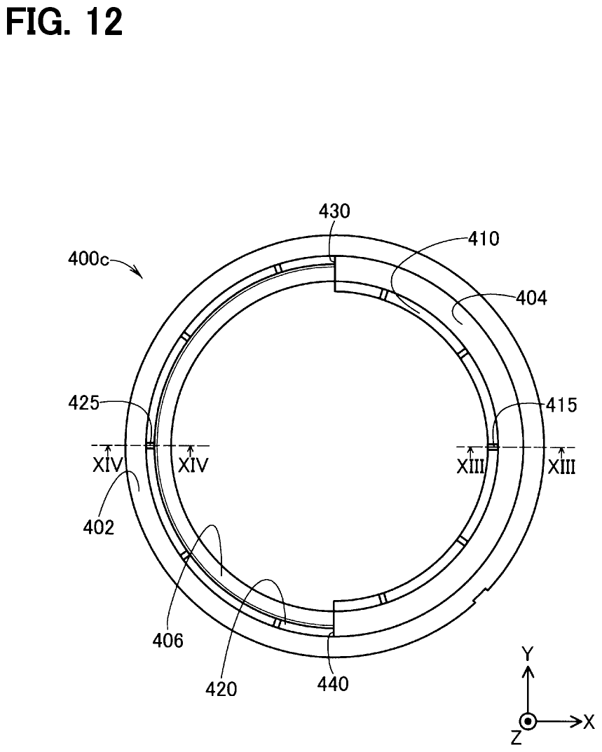

FIG. 12 shows a seal member 400c of the valve device in accordance with the fourth embodiment. The seal member 400c is a modification of the seal member 400 in the first embodiment, and the seal member 400c has a first rib 415 and a second rib 425. The same symbol with the first embodiment represents the same composition in the preceding explanations. The first projection 410 has a first surface inclined to face the inside the seal member. The first surface has the five first ribs 415 shown in FIG. 12. The second projection 420 has a second surface inclined to face the valve element. The second projection 420 has the five second ribs 425 shown in FIG. 12.

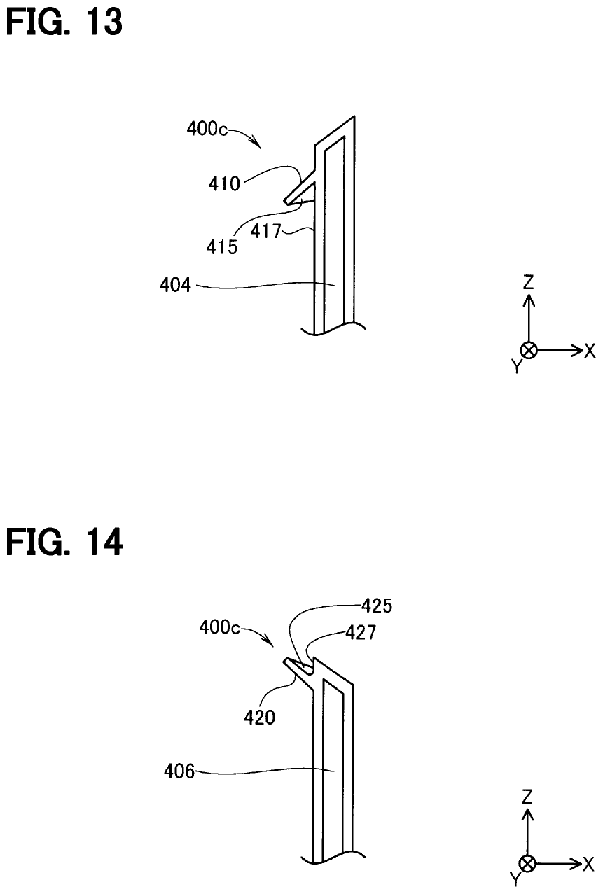

FIG. 13 shows the cross-section view of the middle of the protruding wall 404 in the Z axis. To be concrete, FIG. 13 is a cross-section view of the protruding wall 404 taken along the line XIII-XIII in FIG. 12. In the seal member 400c, the first projection 410 has the first rib 415 that connects the first surface and the surface 417 facing inside the seal member 400c.

FIG. 14 shows the cross-section view of the middle of the protruding wall 406 in the Z axis. To be concrete, FIG. 14 is a cross-section view of the protruding wall 406 taken along the line XIV-XIV in FIG. 12. In the seal member 400c, the second projection 420 has the second rib 425 that connects the second surface and the surface 427 facing outside the seal member 400c.

The fourth embodiment described above can prevent the first projection 410 from bending in the wrong direction (+Z) and the second projection 420 from bending in the wrong direction (−Z).

### Other Embodiments

The seal member of the valve device in each embodiment described above may be produced with a method below. The seal member 400 may be produced by injection molding. A mold for the injection molding is designed so that the first end and the second end of the second projection 420 are separated from the first pressure receiving surface 430 and the second pressure receiving surface 440 respectively. With this method, the producing processes can be reduced compared to a comparative producing method of the seal member in which two ends of the second projection 420 are respectively connected with the first pressure receiving surface 430 and the second pressure receiving surface 440 and then separated from each other.

To form the seal member 400, it is possible to form the first end of the second projection 420 and the first pressure receiving surface 430 connected with each other, and the second end of the second projection and the second pressure receiving surface 440 connected with each other. After that, the first end of the second projection 420 and the first pressure receiving surface 430 are separated from each other using laser. And the second end of the second projection and the second pressure receiving surface 440 are separated from each other using laser. In this case, the first end of the second projection 420 and the first pressure receiving surface 430 can be accurately separated from each other, and the second end of the second projection 420 and the second pressure receiving surface can be accurately separated from each other.

To form the seal member 400, the first end of the second projection 420 and the first pressure receiving surface 430 can be separated from each other using a cutter, and the second end of the second projection and the second pressure receiving surface 440 can be separated from each other using a cutter. In this modification, as the thinner the cutter is, the gap between the first end of the second projection 420 and the first pressure receiving surface 430 can be made smaller, and between the second end of the second projection 420 and the second pressure receiving surface 440 can be made smaller. Thus, the sealing property in bending of the second projection 420 is improved.

It should be appreciated that the present disclosure is not limited to the embodiments and variations described above and can be modified appropriately within the scope of the appended claims. For example, the technical features in each embodiment and variation can be replaced and combined appropriately to solve a part or all of the issues or to achieve a part or all of the effects. In addition, the technical features can be deleted appropriately as long as the features are explained as essential in the present description.

What is claimed is:

1. A valve device comprising:
a valve element;
a housing that houses the valve element; and
a rotary shaft supporting the valve element rotatable in the housing, wherein
the housing has:
an opening configured to receive fluid; and
a seal member located along an inner peripheral part of the opening, the seal member having a cylindrical shape,
the valve element is configured to rotate by being rotated by the rotary shaft, the valve element rotating in an opening direction for opening the opening and rotating in a closing direction for closing the opening,
the seal member has:
a first projection protruded from an inner surface of the seal member on a first side in the closing direction;
a second projection protruded from an outer surface of the seal member on a second side in the opening direction and located further from the rotary shaft than the first projection;
a first pressure receiving surface located between a first end of the first projection and a first end of the second projection adjacent to each other; and
a second pressure receiving surface located between a second end of the first projection and a second end of the second projection adjacent to each other,
the valve element has:
a first pressing curved surface configured to press the first projection;
a second pressing curved surface configured to press the second projection;
a first pressing surface configured to press the first pressure receiving surface; and
a second pressing surface configured to press the second pressure receiving surface, and
the first end and the second end of the second projection are not connected to other parts of the seal member.

2. The valve device according to claim 1, wherein
a gap between the first end of the second projection and the first pressure receiving surface gets wider from an inner side to an outer side in a radial direction of the seal member, and
a gap between the second end of the second projection and the second pressure receiving surface gets wider from an inner side to an outer side in the radial direction of the seal member.

3. The valve device according to claim 1, wherein
a part of the seal member between the first end of the second projection and the first pressure receiving surface, and a part of the seal member between the second end of the second projection and the second pressure receiving surface are curve-shaped when being viewed in a depth direction of the opening.

4. The valve device according to claim 1, wherein
the first projection has a first surface inclined to face the inside the seal member,
the second projection has a second surface inclined to face the valve element,
the first projection includes a first rib that connects the first surface of the first projection and the inner surface of the seal member, and
the second projection includes a second rib that connects the second surface of the second projection and the outer surface of the seal member.

5. A method of producing the valve device according to claim 1 comprising:
producing the seal member by injection molding with a mold, wherein
the mold is designed to separate the first end of the second projection from the first pressure receiving surface, and the second end of the second projection from the second pressure receiving surface.

6. A method of producing the valve device according to claim 1 comprising:
producing the seal member in which the first end and the second end of the second projection are respectively connected with the first pressure receiving surface and the second pressure receiving surface;
separating the first end of the second projection from the first pressure receiving surface using laser, and
separating the second end of the second projection from the second pressure receiving surface using laser.

7. A method of producing the valve device according to claim 1 comprising:
producing the seal member in which the first end and the second end of the second projection are respectively connected with the first pressure receiving surface and the second pressure receiving surface;
separating the first end of the second projection from the first pressure receiving surface using a cutter, and
separating the second end of the second projection from the second pressure receiving surface using a cutter.
